(19) United States
(12) Patent Application Publication
(10) Pub. No.: US 2025/0035446 A1
(43) Pub. Date: Jan. 30, 2025

(54) SPATIAL AWARENESS VIA GAP FILLING

(71) Applicant: QUALCOMM Incorporated, San Diego, CA (US)

(72) Inventors: Anantharaman BALASUBRAMANIAN, San Diego, CA (US); Dan VASSILOVSKI, Del Mar, CA (US)

(21) Appl. No.: 18/358,366

(22) Filed: Jul. 25, 2023

(51) Int. Cl. G01C 21/30; G01C 21/36; G06V 10/26; G06V 20/58

(52) U.S. Cl. CPC G01C 21/30; G01C 21/3667; G06V 10/26; G06V 20/58

(57) ABSTRACT

Techniques for providing spatial awareness to a user equipment (UE) such as an on-board unit (OBU) of a vehicle is disclosed. In some embodiments, such techniques may include: receiving first contextual information from a plurality of OBUs, the first contextual information comprising optically sensed information, spatially sensed information, or a combination thereof obtained by the plurality of OBUs; generating a gap-filling message customized for a given OBU of the plurality of OBUs based on a set of contextual information derived from the received first contextual information, the set of contextual information comprising a union of (i) the first contextual information and (ii) second contextual information comprising optical information, spatial information, or a combination thereof known to the given OBU, such that the first contextual information and the second contextual information do not overlap in the set of contextual information; and sending the gap-filling message to the given OBU.

### BACKGROUND

### 1. Field of Disclosure

The present disclosure relates generally to the field of wireless communications, and more specifically to providing sensed information to user equipment (UE), such as an on-board unit (OBU) of a vehicle, using radio frequency (RF) signals.

### 2. Description of Related Art

A UE (such as an OBU of a vehicle) may be capable of sensing objects in its environment, such as using optical sensing (e.g., using a camera) or radio frequency (RF)-based sensing. The UE may possess spatial awareness using, e.g., information about sensed objects, its own location, and/or information known to the UE. Moreover, other UEs may contribute to the information about sensed objects using situational awareness messages, resulting in a body of crowdsourced information.

### BRIEF SUMMARY

In some aspects of the present disclosure, a method of providing spatial awareness to a user equipment (UE) is disclosed. In some embodiments, the UE may include an on-board unit (OBU) of a vehicle, and the method may include: receiving first contextual information from a plurality of OBUs, the first contextual information comprising optically sensed information, spatially sensed information, or a combination thereof obtained by the plurality of OBUs; generating a gap-filling message customized for a given OBU of the plurality of OBUs based on a set of contextual information derived from the received first contextual information, the set of contextual information comprising a union of (i) the first contextual information obtained by the plurality of OBUs and (ii) second contextual information comprising optical information, spatial information, or a combination thereof known to the given OBU, such that the first contextual information obtained by the plurality of OBUs and the second contextual information known to the given OBU do not overlap in the set of contextual information; and sending the gap-filling message to the given OBU.

In some aspects of the present disclosure, an apparatus is disclosed. In some embodiments, the apparatus may include: one or more data communication interfaces; one or more memory; and one or more processors communicatively coupled to the one or more data communication interfaces and the one or more memory, the one or more processors configured to: receive first contextual information from a plurality of OBUs, the first contextual information comprising optically sensed information, spatially sensed information, or a combination thereof obtained by the plurality of OBUs; generate a gap-filling message customized for a given OBU of the plurality of OBUs based on a set of contextual information derived from the received first contextual information, the set of contextual information comprising a union of (i) the first contextual information obtained by the plurality of OBUs and (ii) second contextual information comprising optical information, spatial information, or a combination thereof known to the given OBU, such that the first contextual information obtained by the plurality of OBUs and the second contextual information known to the given OBU do not overlap in the set of contextual information; and send the gap-filling message to the given OBU.

In some embodiments, the apparatus may include: means for receiving first contextual information from a plurality of OBUs, the first contextual information comprising optically sensed information, spatially sensed information, or a combination thereof obtained by the plurality of OBUs; means for generating a gap-filling message customized for a given OBU of the plurality of OBUs based on a set of contextual information derived from the received first contextual information, the set of contextual information comprising a union of (i) the first contextual information obtained by the plurality of OBUs and (ii) second contextual information comprising optical information, spatial information, or a combination thereof known to the given OBU, such that the first contextual information obtained by the plurality of OBUs and the second contextual information known to the given OBU do not overlap in the set of contextual information; and means for sending the gap-filling message to the given OBU.

In some aspects of the present disclosure, a non-transitory computer-readable apparatus is disclosed. In some embodiments, the non-transitory computer-readable apparatus includes a storage medium, the storage medium comprising a plurality of instructions configured to, when executed by one or more processors, cause an apparatus to: receive first contextual information from a plurality of OBUs, the first contextual information comprising optically sensed information, spatially sensed information, or a combination thereof obtained by the plurality of OBUs; generate a gap-filling message customized for a given OBU of the plurality of OBUs based on a set of contextual information derived from the received first contextual information, the set of contextual information comprising a union of (i) the first contextual information obtained by the plurality of OBUs and (ii) second contextual information comprising optical information, spatial information, or a combination thereof known to the given OBU, such that the first contextual information obtained by the plurality of OBUs and the second contextual information known to the given OBU do not overlap in the set of contextual information; and send the gap-filling message to the given OBU.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a diagram of a communication system, according to an embodiment.

FIG. 2A is a diagram of an example scenario of an environment involving vehicles, a vulnerable road user (VRU), and occlusions. FIG. 2B is a diagram of another example scenario of an environment involving vehicles, a VRU, and occluding objects.

FIG. 2C is a diagram showing top views of the environment of FIG. 2B.

FIG. 3 is a diagram showing an example of how beamforming may be performed, according to some embodiments.

FIG. 4 is a diagram showing an example of a frame structure for NR and associated terminology.

FIG. 5 is a diagram showing an example of a radio frame sequence with Positioning Reference Signal (PRS) positioning occasions.

FIG. 6 is a block diagram of an embodiment of a UE, which can be utilized in embodiments as described herein.

FIG. 7 is a block diagram of an embodiment of a computer system, which can be utilized in embodiments as described herein.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, unless otherwise specified, references to “reference signals,” “positioning reference signals,” “reference signals for positioning,” and the like may be used to refer to signals used for positioning of a user equipment (UE). As described in more detail herein, such signals may comprise any of a variety of signal types but may not necessarily be limited to a Positioning Reference Signal (PRS) as defined in relevant wireless standards.

Further, unless otherwise specified, the term “positioning” as used herein may absolute location determination, relative location determination, ranging, or a combination thereof. Such positioning may include and/or be based on timing, angular, phase, or power measurements, or a combination thereof (which may include RF sensing measurements) for the purpose of location or sensing services.

Various aspects relate generally to wireless communication and networking, and more particularly to sharing of contextual spatial awareness information. Some aspects more specifically relate to creating a gap-filling message based on contextual information from UEs. In example scenarios, a UE may include an on-board unit (OBU) of a vehicle. Contextual information may include spatially sensed information such as optical images, RF sensing data, location information, capabilities information, and others, contained in awareness messages. In some examples, the gap-filling message may be constructed at a networked entity such as a server based on contextual information obtained from multiple UEs in an environment. More particularly, in some implementations, a UE-specific gap-filling message may be a set difference between a global view of the environment and information known to a recipient UE, where the global view may be a union of contextual information from the multiple UEs, such that there is no overlapping or redundant or duplication information from the multiple UEs. This way, the gap-filling message may contain only information customized to the recipient UE which the recipient UE does not possess. Instead, each UE can send information to the server via an appropriate network (e.g., cellular, wireless local area network (WLAN)). The UE-specific gap-filling message may be sent to the recipient UE, e.g., via unicast. In some implementations, a region-specific gap-filling message may be a union of gap-filling messages tailored to UEs in a defined region or zone, and may be sent to UEs of interest, e.g., via multicast or broadcast.

Particular aspects of the subject matter described in this disclosure can be implemented to realize one or more of the following potential advantages. In some examples, by generating a customized gap-filling message that only contains spatially sensed information that the recipient UE, the described techniques can be used to reduce spectrum usage and bandwidth overhead typically associated with awareness messages shared with nearby UEs via sidelink. Typical sidelink messages or crowdsourced messages from the server could have information collected from numerous UEs and contain duplicate information, which may be a waste of spectrum and bandwidth when broadcast repeatedly. Moreover, an existing cellular network and/or access point can be leveraged to free up spectrum and bandwidth as well as offload computational burdens to the server (rather than the vehicle OBU). Using the gap-filling message, a UE such as an OBU of a vehicle can gain awareness of the environment. For example, the OBU may gain awareness and information about a pedestrian at risk of collision approaching from a street that the vehicle cannot see because of an occluding object such as a building.

Additional details will follow after an initial description of relevant systems and technologies.

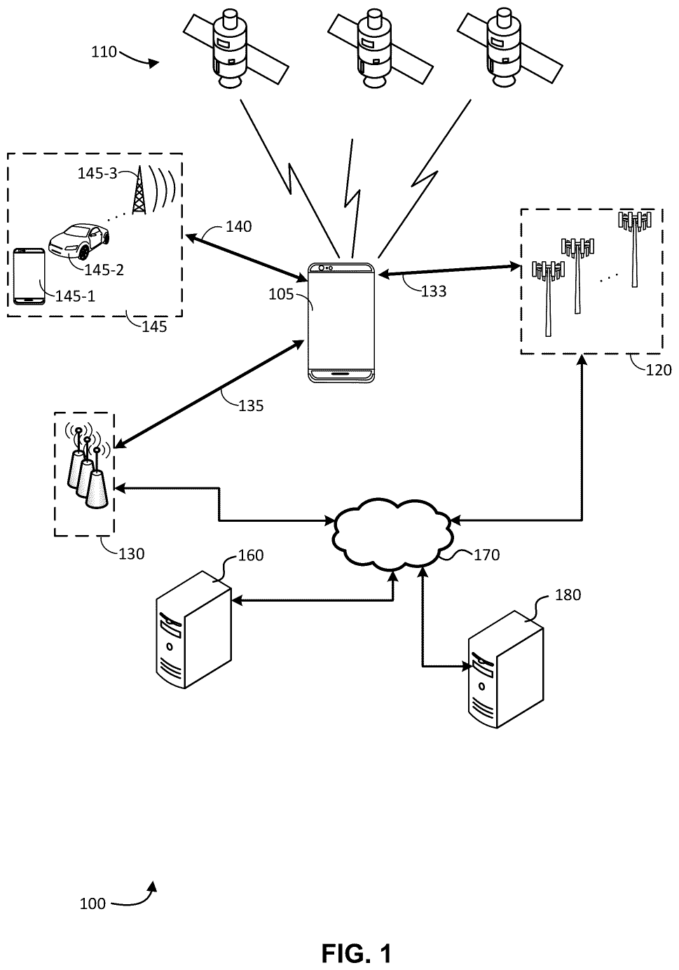

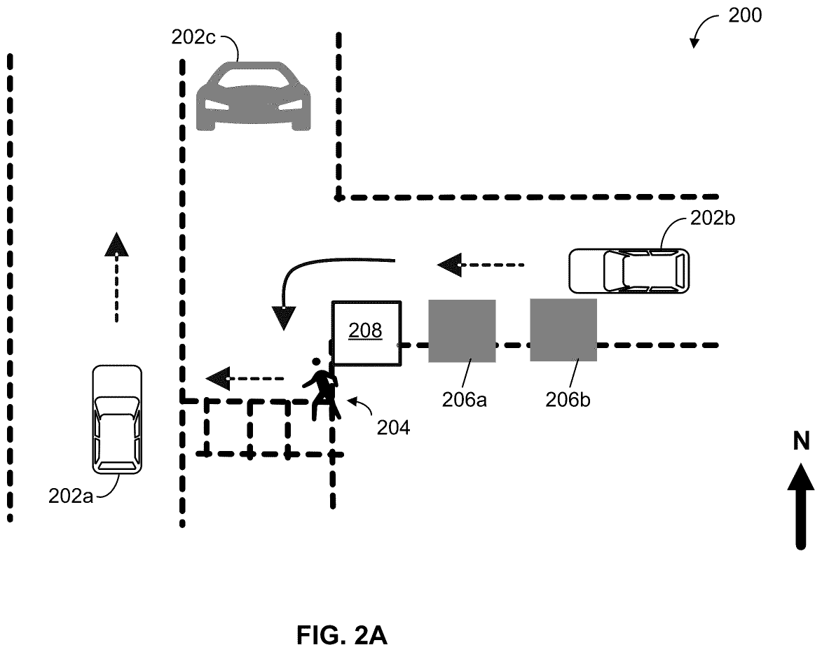

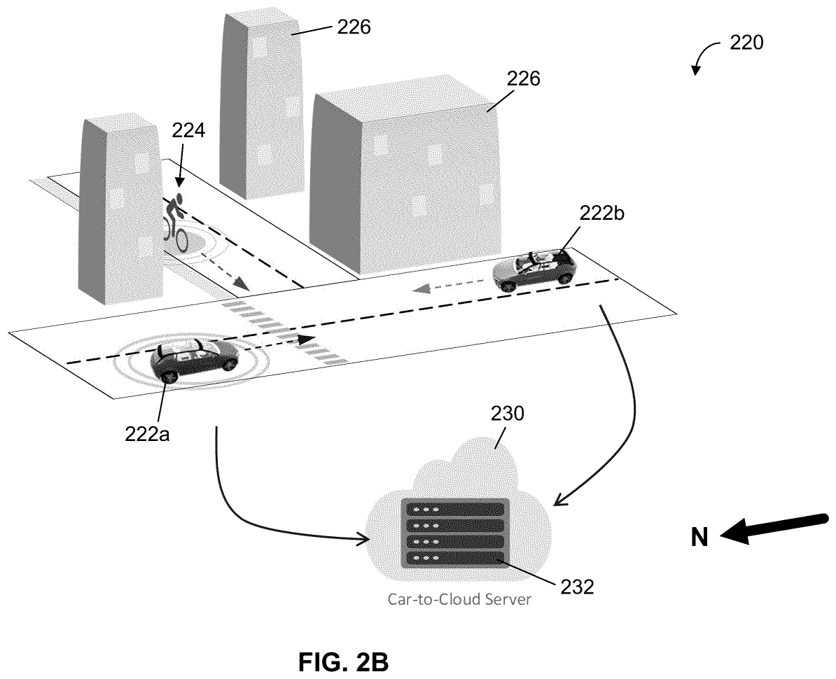

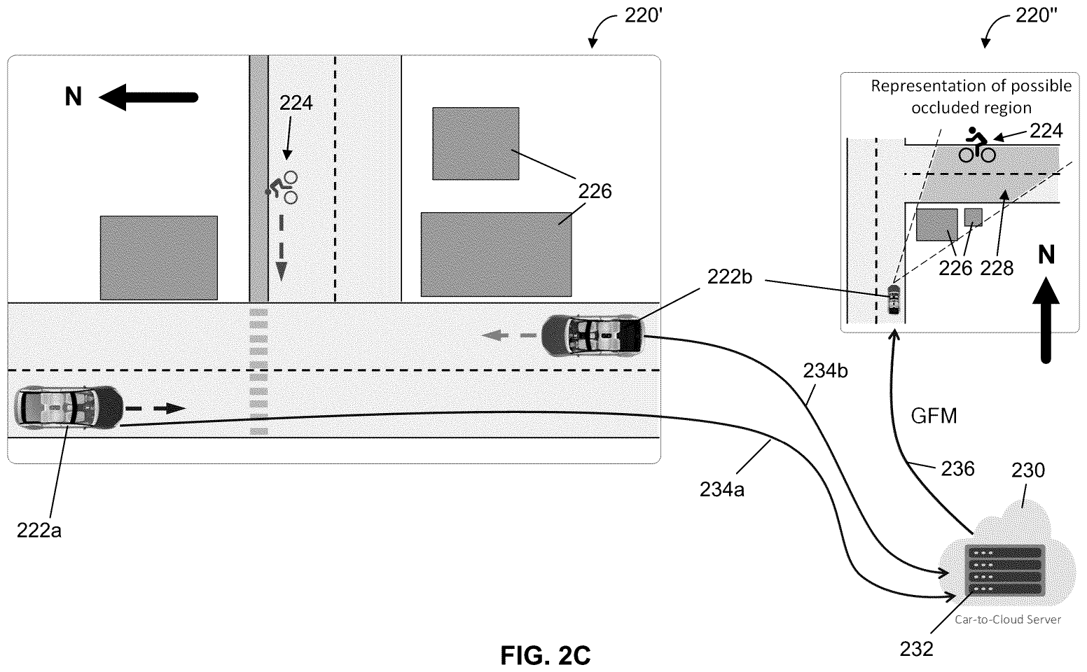

FIG. 1 is a simplified illustration of a communication system 100 in which a UE 105, location server 160, and/or other components of the communication system 100 can use the techniques provided herein for providing awareness information or messages to UE 105, according to an embodiment. The techniques described herein may be implemented by one or more components of the communication system 100. The communication system 100 can include: a UE 105; one or more satellites 110 (also referred to as space vehicles (SVs)), which may include Global Navigation Satellite System (GNSS) satellites (e.g., satellites of the Global Positioning System (GPS), GLONASS, Galileo, Beidou, etc.) and/or Non-Terrestrial Network (NTN) satellites; base stations 120; access points (APs) 130; location server 160; network 170; and external client 180. Generally put, the communication system 100 can estimate a location of the UE 105 based on RF signals received by and/or sent from the UE 105 and known locations of other components (e.g., GNSS satellites 110, base stations 120, APs 130) transmitting and/or receiving the RF signals. Additional details regarding particular location estimation techniques are discussed in more detail with regard to FIG. 2.

It should be noted that FIG. 1 provides only a generalized illustration of various components, any or all of which may be utilized as appropriate, and each of which may be duplicated as necessary. Specifically, although only one UE 105 is illustrated, it will be understood that many UEs (e.g., hundreds, thousands, millions, etc.) may utilize the communication system 100. Similarly, the communication system 100 may include a larger or smaller number of base stations 120 and/or APs 130 than illustrated in FIG. 1. The illustrated connections that connect the various components in the communication system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUS), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, UE 105 can send and receive information with network-connected devices, such as location server 160, by accessing the network 170 via a base station 120 using a first communication link 133. Additionally or alternatively, because APs 130 also may be communicatively coupled with the network 170, UE 105 may communicate with network-connected and Internet-connected devices, including location server 160, using a second communication link 135, or via one or more other mobile devices 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP. Physical transmission points may comprise an array of antennas of a base station 120 (e.g., as in a Multiple Input-Multiple Output (MIMO) system and/or where the base station employs beamforming). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As used herein, the term “cell” may generically refer to a logical communication entity used for communication with a base station 120, and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

Satellites 110 may be utilized for positioning of the UE 105 in one or more ways. For example, satellites 110 (also referred to as space vehicles (SVs)) may be part of a Global Navigation Satellite System (GNSS) such as the Global Positioning System (GPS), GLONASS, Galileo or Beidou. Positioning using RF signals from GNSS satellites may comprise measuring multiple GNSS signals at a GNSS receiver of the UE 105 to perform code-based and/or carrier-based positioning, which can be highly accurate. Additionally or alternatively, satellites 110 may be utilized for NTN-based positioning, in which satellites 110 may functionally operate as TRPs (or TPs) of a network (e.g., LTE and/or NR network) and may be communicatively coupled with network 170. In particular, reference signals (e.g., PRS) transmitted by satellites 110 NTN-based positioning may be similar to those transmitted by base stations 120, and may be coordinated by a location server 160. In some embodiments, satellites 110 used for NTN-based positioning may be different than those used for GNSS-based positioning. In some embodiments NTN nodes may include non-terrestrial vehicles such as airplanes, balloons, drones, etc., which may be in addition or as an alternative to NTN satellites.

The location server 160 may comprise a server and/or other computing device configured to determine an estimated location of UE 105 and/or provide data (e.g., “assistance data”) to UE 105 to facilitate location measurement and/or location determination by UE 105. According to some embodiments, location server 160 may comprise a Home Secure User Plane Location (SUPL) Location Platform (H-SLP), which may support the SUPL user plane (UP) location solution defined by the Open Mobile Alliance (OMA) and may support location services for UE 105 based on subscription information for UE 105 stored in location server 160. In some embodiments, the location server 160 may comprise, a Discovered SLP (D-SLP) or an Emergency SLP (E-SLP). The location server 160 may also comprise an Enhanced Serving Mobile Location Center (E-SMLC) that supports location of UE 105 using a control plane (CP) location solution for LTE radio access by UE 105. The location server 160 may further comprise a Location Management Function (LMF) that supports location of UE 105 using a control plane (CP) location solution for NR or LTE radio access by UE 105.

In a CP location solution, signaling to control and manage the location of UE 105 may be exchanged between elements of network 170 and with UE 105 using existing network interfaces and protocols and as signaling from the perspective of network 170. In a UP location solution, signaling to control and manage the location of UE 105 may be exchanged between location server 160 and UE 105 as data (e.g. data transported using the Internet Protocol (IP) and/or Transmission Control Protocol (TCP)) from the perspective of network 170.

As previously noted (and discussed in more detail below), the estimated location of UE 105 may be based on measurements of RF signals sent from and/or received by the UE 105. In particular, these measurements can provide information regarding the relative distance and/or angle of the UE 105 from one or more components in the communication system 100 (e.g., GNSS satellites 110, APs 130, base stations 120). The estimated location of the UE 105 can be estimated geometrically (e.g., using multiangulation and/or multilateration), based on the distance and/or angle measurements, along with known position of the one or more components.

Although terrestrial components such as APs 130 and base stations 120 may be fixed, embodiments are not so limited. Mobile components may be used. For example, in some embodiments, a location of the UE 105 may be estimated at least in part based on measurements of RF signals 140 communicated between the UE 105 and one or more other mobile devices 145, which may be mobile or fixed. As illustrated, other mobile devices may include, for example, a mobile phone 145-1, vehicle 145-2, static communication/positioning device 145-3, or other static and/or mobile device capable of providing wireless signals used for positioning the UE 105, or a combination thereof. Wireless signals from mobile devices 145 used for positioning of the UE 105 may comprise RF signals using, for example, Bluetooth® (including Bluetooth Low Energy (BLE)), IEEE 802.11x (e.g., Wi-Fi®), Ultra Wideband (UWB), IEEE 802.15x, or a combination thereof. Mobile devices 145 may additionally or alternatively use non-RF wireless signals for positioning of the UE 105, such as infrared signals or other optical technologies.

Mobile devices 145 may comprise other UEs communicatively coupled with a cellular or other mobile network (e.g., network 170). When one or more other mobile devices 145 comprising UEs are used in the position determination of a particular UE 105, the UE 105 for which the position is to be determined may be referred to as the “target UE,” and each of the other mobile devices 145 used may be referred to as an “anchor UE.” For position determination of a target UE, the respective positions of the one or more anchor UEs may be known and/or jointly determined with the target UE. Direct communication between the one or more other mobile devices 145 and UE 105 may comprise sidelink and/or similar Device-to-Device (D2D) communication technologies. Sidelink, which is defined by 3GPP, is a form of D2D communication under the cellular-based LTE and NR standards. UWB may be one such technology by which the positioning of a target device (e.g., UE 105) may be facilitated using measurements from one or more anchor devices (e.g., mobile devices 145).

According to some embodiments, such as when the UE 105 comprises and/or is incorporated into a vehicle, a form of D2D communication used by the mobile device 105 may comprise vehicle-to-everything (V2X) communication. V2X is a communication standard for vehicles and related entities to exchange information regarding a traffic environment. V2X can include vehicle-to-vehicle (V2V) communication between V2X-capable vehicles, vehicle-to-infrastructure (V2I) communication between the vehicle and infrastructure-based devices (commonly termed roadside units (RSUs)), vehicle-to-person (V2P) communication between vehicles and nearby people (pedestrians, cyclists, and other road users), and the like. Further, V2X can use any of a variety of wireless RF communication technologies. Cellular V2X (CV2X), for example, is a form of V2X that uses cellular-based communication such as LTE (4G), NR (5G) and/or other cellular technologies in a direct-communication mode as defined by 3GPP. The UE 105 illustrated in FIG. 1 may correspond to a component or device on a vehicle, RSU, or other V2X entity that is used to communicate V2X messages. In embodiments in which V2X is used, the static communication/positioning device 145-3 (which may correspond with an RSU) and/or the vehicle 145-2, therefore, may communicate with the UE 105 and may be used to determine the position of the UE 105 using techniques similar to those used by base stations 120 and/or APs 130 (e.g., using multiangulation and/or multilateration). It can be further noted that mobile devices 145 (which may include V2X devices), base stations 120, and/or APs 130 may be used together (e.g., in a WWAN positioning solution) to determine the position of the UE 105, according to some embodiments.

In some scenarios, UE 105 may be or include an on-board unit (OBU). An OBU is a device that may be installed in, coupled to, connected to, or otherwise associated with another object, such as a vehicle. Hence, an OBU can be used to perform sidelink, D2D, and/or V2X communication as described above. An OBU may also be configured to transmit and collect sensed information and data. For example, an OBU may include one or more sensors or sensing systems, such as at least one optical sensor (e.g., camera) for capturing visual information, at least one RF sensors or detectors such radar or lidar sensors, and/or at least one acoustic system such as sonar. An OBU may also include a modem and/or a transceiver having one or more of various data communication interfaces for wireless communication (e.g., via a cellular network or WLAN) and perform wireless communication using the interfaces. These sensors and interfaces can be used to perform various actions. Examples of such actions may include connecting to a data network, including base stations, access points, and/or servers; obtaining, receiving, or sending information about the OBU or the vehicle or the environment the OBU is in (e.g., location of the OBU or vehicle, traffic and driving data, objects around the OBU or vehicle); and/or connecting to roadside and satellite navigation systems such as RSUs and GNSS satellites 110.

As a further example, an OBU can be configured to exchange information or otherwise communicate with other OBUs (or other devices, including RSUs) periodically, upon request, or otherwise. Information can be sent or received via messages such as a Basic Safety Message (BSM), a Personal Safety Message (PSM), a Collective Perception Message (CPM), and/or a Sensor Data Sharing Message (SDSM). A BSM may include information about vehicle status, such as speed, position, steering wheel angle, acceleration, heading (direction), path history, and/or vehicle type. A PSM may include Pedestrian to Vehicle (P2V) safety information regarding different types of vulnerable road users (VRUs). A VRU may be any non-automobile road user (such as a pedestrian, motorist, or road worker), an animal-drawn vehicle, or person with disability or reduced mobility and orientation (on, e.g., a wheelchair). A CPM may include information about the OBU (e.g., position, heading), information about the vehicle (e.g., sensor information), and information about perceived objects (e.g., position, speed, dimensions). An SDSM may include sensor data. Other types of V2X messages such as Maneuver Coordination Messages (MCM) or Toll Advertisement Message (TAM) may be exchanged. The aforementioned data can be broadcast or multicast (e.g., via sidelink). However, in some embodiments, this data can be sent by the OBU to the network (e.g., to a server).

An estimated location of UE 105 can be used in a variety of applications-e.g. to assist direction finding or navigation for a user of UE 105 or to assist another user (e.g. associated with external client 180) to locate UE 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of UE 105 may comprise an absolute location of UE 105 (e.g. a latitude and longitude and possibly altitude) or a relative location of UE 105 (e.g. a location expressed as distances north or south, east or west and possibly above or below some other known fixed location (including, e.g., the location of a base station 120 or AP 130) or some other location such as a location for UE 105 at some known previous time, or a location of a mobile device 145 (e.g., another UE) at some known previous time). A location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which UE 105 is expected to be located with some level of confidence (e.g. 95% confidence).

The external client 180 may be a web server or remote application that may have some association with UE 105 (e.g. may be accessed by a user of UE 105) or may be a server, application, or computer system providing a location service to some other user or users which may include obtaining and providing the location of UE 105 (e.g. to enable a service such as friend or relative finder, or child or pet location). Additionally or alternatively, the external client 180 may obtain and provide the location of UE 105 to an emergency services provider, government agency, etc.

FIG. 2A illustrates a diagram of an example scenario of an environment 200 involving vehicles 202a-202c, a vulnerable road user (VRU) 204, and occluding objects 206a and 206b. One or more of the vehicles 202a-202c shown in FIG. 2A may include a corresponding OBU or other UE. Vehicle 202a may be heading north. Vehicle 202b may be heading west and trying to turn south. Vehicle 202c may be stationary. Vehicles 202a and 202c may have visual line of sight (e.g., via optical sensors such as cameras and/or via RF sensors) and “see” VRU 204, a pedestrian crossing a crosswalk. However, vehicle 202b may not see the VRU 204 because of occlusions (e.g., buildings) 206a and 206b blocking the line of sight between the vehicle 202b and the VRU 204. An RSU 208 may also be present and at least partially blocking the line of sight to the VRU 204.

As illustrated with respect to vehicle 202b, it is not always feasible to sense all objects (such as a pedestrian) in the environment for a full situational spatial awareness. For example, occluding objects (e.g., buildings) 206a and 206b can block the line of sight of a VRU 204 (e.g., crossing pedestrian), even if the OBU of the vehicle 202b were to use all of various sensors (e.g., camera, lidar, radar) available to it. In such a situation, the lack of situational awareness by the vehicle 202b can pose a danger to the pedestrian, as there is no guarantee that the vehicle 202b can obtain an accurate sense of its surroundings by using all its sensors because of occlusions and mobility of other objects.

Typically, to address the inability of OBUs and vehicles to obtain an accurate sense of its surroundings, sensor sharing may be used, where vehicles exchange information about sensed objects. For instance, OBUs of vehicles 202a and 202c can share situational awareness messages via V2X. The OBUs may be multicast or broadcast messages such as BSM, CPM and/or SDSM via sidelink communication to enable other vehicles to reconstruct a global view of the environment. This way, vehicle 202b may be able to obtain a fuller awareness of the objects surrounding it, including position and velocity of VRU 204.

However, giving all vehicles the full spatial awareness can be a waste of spectrum usage, since there may be duplicative or overlapping information, especially for, e.g., vehicles that are near each other. Moreover, given the range limitations of V2X, not all vehicles may be within sensing range of other vehicles to be able to receive situational awareness messages. For instance, it may be the case that vehicle 202c is too far away from vehicle 202b to send a message containing information about VRU 204. In some scenarios, sensing information may be less accurate because of the types of objects in the environment, or weather such as rain which may increase occlusion and make sensing difficult.

In contrast, a centralized entity such as a networked (cloud) server may be better positioned to receive awareness messages from multiple UEs and OBUs, and construct a global spatial view of the environment from multiple sources of information, not just from OBUs but also from known information (e.g., a map of the area, and/or known objects, streets, walkways, crosswalks, traffic information, etc.). Additionally, it may be more bandwidth- and spectrum-efficient to send each vehicle a customized message from the network where the message is specifically tailored to the vehicle to selectively include only relevant information that the vehicle does not have, as opposed to sending every vehicle all the information (including duplicative or overlapping information).

FIG. 2B depicts a diagram of an example scenario of an environment 220 involving vehicles 222a and 222b, a VRU 224, and one or more occluding objects 226, where the vehicles 222a and 222b are configured for communication with a server 232. More specifically, the OBUs of the vehicles 222a and 222b may connect to the server 232 via a data network 230 using an appropriate data interface (e.g., via an LTE or NR base station, or a WLAN access point). The server 232 may be an example of location server 160, and capable of receiving sensed information from at least the vehicles 222a and 222b.

In this example scenario, the VRU 224 is in the field of view of the OBU of the vehicle 222a (e.g., in line of sight of a camera or other sensor of vehicle 222a) but is not in view of the OBU of the vehicle 222b. Based on the direction of heading of vehicle 222b and that of the VRU 224, there may be a risk of collision between them. One possible approach to resolve the risk of collision would be to enable vehicle 222b to detect VRU 224, which in this scenario vehicle 222b is unable to do using its sensors (e.g., camera, radar, lidar) because of occlusion by a building 226. Information regarding the VRU 224 could be sent by the vehicle 222a to the server 232 and may be useful to vehicle 222b as a precautionary measure for the risk of collision.

However, although sensor sharing and exchange of awareness messages (e.g., with vehicle 222a) could be used to obtain such information regarding the VRU 224, it can involve an excessive amount of overhead. For example, an excessive amount of spectrum overhead required for multicast or broadcast of sensor sharing messages (e.g., via sidelink), computational overhead of each vehicle to construct a global view from multiple sensor messages, and/or bandwidth overhead for vehicles to receive the global view from the server, especially as the number of vehicles, OBUs, and VRUs increases (e.g., in a busy intersection). Moreover, multiple nearby vehicles may end up providing the same sensor sharing messages, which is wasteful of the aforementioned resources. This overhead can also become a bottleneck or quickly outdated in high-velocity situations requiring equally fast action by an operator of the vehicle, e.g., on a highway. Further, not all vehicles may have V2X technology in the first place to exchange awareness messages.

To these ends, it is desirable to provide gaps in situational and spatial awareness information that a given OBU possesses. In one aspect of the present disclosure, a centralized entity such as a cloud server may receive various signaling messages (BSM, PSM, CPM, SDSM, etc.) from OBUs, and could provide gap information that is specific and tailored to a given OBU or a given region. Gap information may be determined and generated based on awareness information collected or crowdsourced from multiple OBUs. In some cases, the gap information may be specific to a given region. In some cases, the gap information may be specific to a given OBU. OBU-specific gap information may be relevant awareness information that was obtained from other OBUs which the given OBU requires but does not have. That is, the gap information may be the “delta” between global information from OBUs and information known to the given OBU. Gap information may be transmitted in a so-called gap-filling message (GFM) as a unicast message to a given OBU (or UE) if OBU-specific, or as a multicast or broadcast message if region-specific.

In another aspect, the server may provide, to the OBU, perception information that pertains to a view that the OBU does not have. For example, a vehicle of the OBU may have a limited frontal view of its environment when behind a large truck (e.g., stuck in traffic). Information known to or obtained by the server (e.g., positions of vehicles, road information, camera or sensor parameters, fields of view of the camera) and information from other vehicles in the vicinity in a particular region may expand the visual knowledge of the OBU, at least within the particular region.

In another aspect, the server may perform or cause performance of dynamic map updates for advanced driver-assistance system (ADAS) of the OBU. For example, visual environmental information such as markers corresponding to buildings and VRUs may be provided to the OBU.

It will be appreciated that while the above aspects are described in terms of OBUs, they are equally applicable to UEs in general, such as a personal UE (e.g., smartphone) or a vehicle UE.

### Gap-Filling Messages

A gap-filling message (GFM) refers to a message containing awareness information obtained from multiple UEs that do not include information known to a particular UE. Hence, a GFM may be tailored and customized to a particular UE such that there is no overlapping or redundant information, advantageously resulting in efficient use and less waste of spectrum and bandwidth since the GFM would provide only the missing information and relevant awareness to the recipient UE, not all known information. As an illustrative point, a traditional non-customized message would contain overlapping information from a recipient UE and information from other UEs. Sending such non-customized messages is less spectrum-and bandwidth-efficient, as alluded to elsewhere herein.

To generate the GFM, UEs such as UEs and OBUs of vehicles, and/or even UEs carried by VRUs (e.g., pedestrians), may first send situational awareness messages, such as BSM, PSM, CPM, SDSM, or a combination thereof. In some embodiments, these messages may be sent to a centralized networked entity such as a cloud server (e.g., location server 160, server 232). The server may construct a global view from these messages. Depending on the scenario or environment, or the zone or region of interest (e.g., for a region-specific GFM), the number of UEs sending the messages may be few (e.g., fewer than ten, fewer than hundred) or numerous (e.g., hundreds, thousands, tens of thousands, hundreds of thousands, or more).

A UE-specific GFM may contain situational awareness information that is of important to a specific UE (e.g., OBU) which the specific UE could not detect by itself because of various reasons, such as occlusion as illustrated in FIGS. 2A and 2B. To further illustrate, an example scenario is depicted in FIG. 2C. FIG. 2C is a diagram showing a top view 220′ and another top view 220″ of the environment 220 of FIG. 2B involving vehicles 222a and 222b, VRU 224, and one or more occluding objects 226, where the vehicles 222a and 222b are configured for communication with a server 232. As with the scenario of FIG. 2B, the OBUs of the vehicles 222a and 222b may communicate with the server 232 using appropriate data interfaces, e.g., connecting with a base station or an access point via communication links 234a, 234b.

It can be seen in the top view 220″ that vehicle 222b is unable to see and have a line of sight to the shaded region 228 because of occlusion from buildings 226. However, the server 232 may have environmental awareness in that region depicted in top views 220′ and 220″ based on situational awareness messages received from the OBU of vehicle 222b and the OBU of vehicle 222a (which can see the shaded region 228 occluded from vehicle 222b), e.g., via communication links 234a, 234b. In some cases, the situational awareness messages may contain various information regarding that region, such as optical and visual information (e.g., optical images, image data) and/or sensed information from RF sensors of vehicle 222a and/or 222b. Such awareness messages may include, e.g., image data of the shaded region 228 from the OBU of vehicle 222a, since the field of view of a sensor (e.g., camera) of the vehicle 222a is not occluded in that region. In some cases, although not explicitly shown via a communication link, the situational awareness messages may contain optical or other sensed information from a UE of VRU 224. The server 232 may thereby construct a global view by crowdsourcing from multiple UEs such as OBUs.

In some embodiments, the server 232 constructs a global view based on message from UEs (e.g., OBUs) of interest. In some situations, the UEs of interest may be UEs within a defined geographic region (e.g., block(s), street(s), intersection, an area having a width and length, an area having a radius) or an identified location (e.g., a park, a mall). In some situations, the UEs of interest may be UEs identified to be within a particular range from a specific UE (e.g., a recipient UE or OBU to receive a customized GFM later). In some situations, the UEs of interest may be certain UEs identified by the network and may not necessarily be all UEs within a region or range.

As used herein, a global view may be considered to be a combination of sensed information (e.g., spatial, optical, visual, RF-based) from multiple UEs which is commonly or jointly applicable to the UEs of interest defined or identified according to the above. In some embodiments, the combination may not necessarily be a simple addition of all the information, but rather can be a union-a set that has all elements belonging to one or more of the multiple UEs, but without overlap. To define such a global view, the following approach may be taken.

Let S₁, S₂, . . . Sₙ be situational awareness messages received by the server 232 from UEs 1, 2, . . . n, respectively. For example, S₁ represents awareness messages from OBU1, S₂ represents awareness messages from OBU2, etc. The global view message (GV) may be defined and constructed as GV=S₁∪S₂. . . ∪Sₙ. Said differently, the global view message may be a union of awareness messages from the UEs. There is no overlapping or redundant or duplicate information within the union. For example, spatially sensed information from OBU1 and OBU2 may have the same information (e.g., location of a building). This information would not be repeated in the union.

In some implementations, a UE-specific GFM may be generated by the server 232. More specifically, server 232 may construct and generate a UE-specific GFM for a given UE (GFMᵢ for UEᵢ). GFMᵢ may be defined as GFMᵢ=GV\Sᵢ, the set difference (or “delta”) between GV and information known to UE/. That is, GFMᵢ may contain all the relevant information specific to UE, except the information that UE is already aware of or knows. The server 232 may send the UE-specific GFMᵢ to UE (e.g., via unicast). UEᵢ may then possess awareness information (e.g., BSM, PSM, CPM, and/or SDSM) that it did not have before.

For example, referring to FIG. 2C as an example, if UEᵢ were the OBU of vehicle 222b, information about shaded region 228 including the existence of VRU 224 may become known to vehicle 222b after its OBU receives GFMᵢ from the server 232.

In some implementations, a region-specific GFM may be generated by the server 232 for a region r. More specifically, server 232 may construct and generate a region-specific GFM(r), which is the gap-filling messages of UEs within the region r. In some cases, as mentioned above, region r may be, for example, determined relative to or with respect to a specific UE (e.g., a certain radius around the specific UE) or determined by a defined region.

Given example UEs i, j, and k, GFM(r) may be defined as GFM(r)ᵢ∪GFMⱼ∪GFMₖ, where GFMᵢ is the set difference between GV and Sᵢ, GFMⱼ is the set difference between GV and Sⱼ, and GFMₖ is the set difference between GV and Sₖ. That is, region-specific GFM(r) may be defined as a union of GFMs of UEs in the region r. The foregoing is an illustrative example. GFM(r) may be based on more or fewer UEs and corresponding GFMs. In a specific scenario, GFM(r) may simply be GFMᵢ if there is only one UE in the region r. In other scenarios, GFM(r) may be based on numerous (more than three) GFMs. Note that GFM(r) may be a subset of GV. In some cases, since GFM(r) can be applicable to UEs within the region r, and thus may be sent to some or all applicable UEs in the region r (e.g., via multicast or broadcast), GFM(r) may be stored at an edge node accessible to the UEs, such as a base station (e.g., gNB, smallcell, femtocell), an access points (e.g., Wi-Fi hotspot), RSU, or other intermediate network entity having storage. In some cases, even a UE may store the GFM(r). In certain implementations, the UE may update the GFM(r) as it moves from one location to another location, where the mobility of the UE may redefine region r, e.g., as a radius around the UE.

In some implementations, a global view and/or a GFM may be constructed by a networked apparatus other than the server 232. For example, certain types of RSU, base stations, access points, or even UEs that are relatively local or on the edge of the network may be capable of generating the global view and thus the GFM (whether GFM, or GFM(r)) according to the above. Some such edge devices may have a communication range or be associated with a region within which UEs can perform data communication with the edge device. In these implementations, the awareness messages from UEs such as OBUs may be sent to such networked apparatus, and the constructed relevant GFM may be unicast to a recipient UE or OBU, or multicast or broadcast to UEs or OBUs in a relevant region.

In some embodiments, the UE (e.g., OBU) may subscribe to a service provided by the server 232 to receive a GFM, e.g., a subscription service with or without a fee. The service may be provided by a mobile network operator (MNO), mobile virtual network operator (MVNO), mobile service operator (MSO), or similar network provider. Depending on configuration or user preference, the user or customer of the UE or OBU may receive GFMs as regular updates (e.g., periodically) from the server 232, receive a GFM “on demand” or responsive to a request from the UE or OBU to the server 232, or both. In the case where a request is sent to the server 232, it may be done as necessary or when necessary, e.g., near intersections in order not to miss a potential VRU. In some cases, the request may be made manually, e.g., by a driver of the vehicle having the OBU. In some cases, the request may be made automatically by the UE or OBU, e.g., if the UE or OBU is at or approaching a location known to have numerous occlusions, a location with high vehicular or pedestrian traffic, roads that are difficult to navigate (e.g., numerous turns or curves, narrow roads), a location that is historically prone to accidents, or otherwise a point of interest or sufficient risk.

In some embodiments, in addition to or alternative to a UE or OBU transmitting situational awareness messages to the server 232, the UE or OBU may transmit one or more parameters related to capabilities or characteristics of the UE or OBU or related components (e.g., a camera or RF sensor installed on the vehicle). For example, the one or more parameters may include image size (e.g., obtained by a camera or RF sensor), focal length of a camera, intrinsic parameter of a sensor (e.g., lens distortion), extrinsic parameter of the sensor (e.g., pitch, roll, yaw). Taking the example of FIGS. 2B and 2C, capability information associated with one or more of the OBUs of the vehicles 222a, 222b (and any others) present in the environment may include one or more camera parameters, one or more radio frequency (RF) sensor parameters, or a combination thereof.

In some embodiments, the server 232 may send UE-specific or region-specific GFM as an informational message for one or more applicable recipient UEs or OBUs to consume or use the GFM, e.g., for enhanced awareness of its surroundings and environment. Referring back to FIG. 2C, a GFM may be sent via communication links 236 to, e.g., vehicle 222b. In some cases, the GFM may include image data (e.g., for an optical image). Image data may be used by the UE or OBU to “see” a perspective that it does not have from its current or past position, a gap that is now filled with the GFM. From this new perspective, the UE or OBU may be able to identify a VRU that it could not before, and the UE or OBU may perform an action accordingly, e.g., provide an alert, slow or stop the vehicle, keep track of the occluded region (e.g., shaded region 228) or the occluded object (e.g., VRU 224), ensure the occlusion is not causing collision potential. In some cases, the GFM may include text, such as a list of objects, object types, and/or corresponding coordinates of objects, including VRUs, vehicles, UEs, etc. that the UE or OBU was unaware of or unable to view. This object information could be used similarly to the image data to enable the UE or OBU to perform an action. The UE or OBU could use both the image data and the text in conjunction to perform an action. As described herein, the GFM is a bandwidth-and spectrum-efficient way to transmit a message that is tailored to the recipient UE or OBU that provides only the missing spatial information.

In some embodiments, the GFM may include perceptual or visual information, which the server 232 may send to a recipient UE or OBU. The perceptual or visual information may include, for example, an indication of location information corresponding to the recipient UE or OBU, an indication of visual occlusion associated with the recipient UE or OBU, and/or similar indications that can be visually consumed, e.g., by a user. As an illustrative example, an icon corresponding to an object (e.g., vehicle, pedestrian, occluding object such a building, or other environmental object such as a base station or a road), and the coordinates or other location information of the object may be sent to the UE or OBU, such that the UE or OBU may display or cause display of the icon at the corresponding coordinates. Depending on the configuration and design, such an icon could be superimposed on a map or navigation application of the UE or OBU (e.g., a display within the vehicle). As another example, a visual indication of the occlusion, such as shaded region 228, could be displayed. In these ways, the server can provide and enable dynamic updates of perceptual or visual information (e.g., dynamic ADAS map updates), which can be visually useful to a driver or passenger of the vehicle of the OBU. In fact, based on these dynamic updates, the perceptual or visual information sent to the UE or OBU could enable display and/or animation of the representation of the top view 220″ shown on the right side of FIG. 2C. If the updates of perceptual or visual information are sufficiently frequent (e.g., once every few seconds, once per second, multiple times per second), the icons may appear to be animated.

Based on the scenario, a UE-specific GFM may be sent via unicast to the applicable UE or OBU (e.g., GFMᵢ would be sent to UEᵢ only). A region-specific GFM may be sent via multicast or broadcast to some or all UEs in the applicable region.

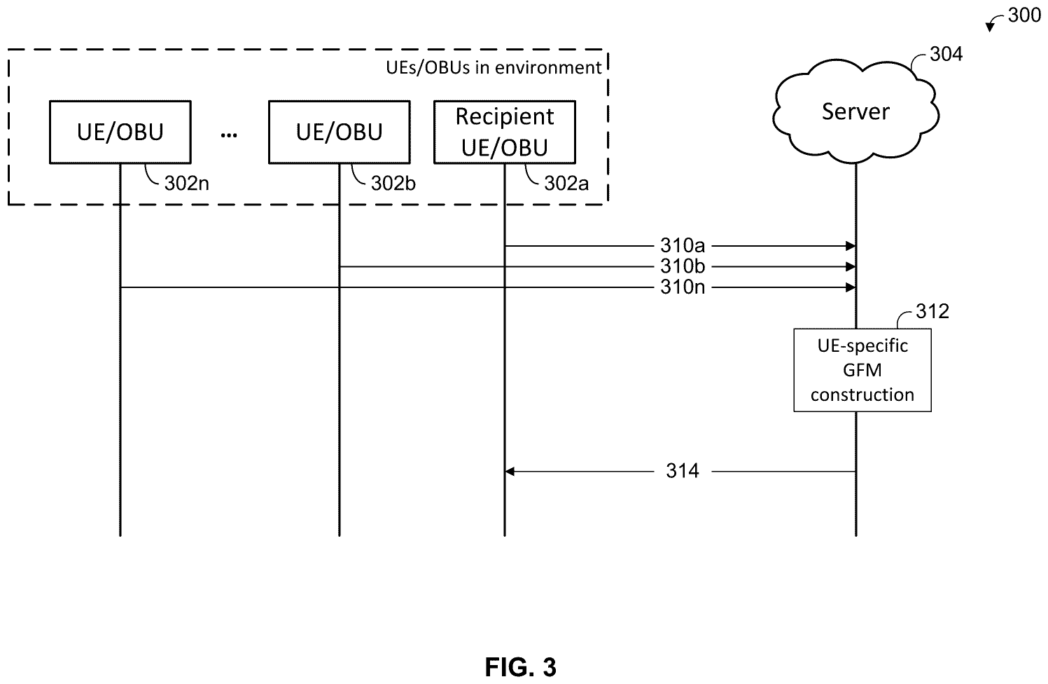

FIG. 3 is a call flow diagram 300 involving UEs 302a, 302b, 302n in an environment, and a server 304, according to some embodiments. At least some of the UEs 302a, 302b, 302n may be examples of OBUs of vehicles 202a-202c, 222a and 222b shown in FIGS. 2B and 2C, and in some scenarios, may include other types of UEs such as a mobile device carried by a VRU (e.g., 204, 224), as such mobile devices may be capable of sensing or obtaining spatial information and send awareness messages (e.g., BSM, PSM, CPM, and/or SDSM). The server 304 may be a networked cloud server such as server 232.

In some example operations of call flow diagram 300, at arrows 310a-310n, the UEs 302a, 302b, 302n may send respective awareness messages to the server 304. The awareness messages may include various types of contextual information about the environment, including spatially sensed information obtained by the UEs. Examples of the spatially sensed information may include image data obtained by the UEs (e.g., via a camera or RF sensor), sensed information associated with said one or more objects (e.g., via an RF sensor), location information corresponding to the UEs (e.g., obtained using positioning methods described above, or from elsewhere, e.g., the network), object information associated with one or more objects within an environment (e.g., object identifiers, object types, object locations or coordinates), occlusion information associated with one or more cameras of one or more vehicles of OBUs (e.g., which part of a camera's field of view is blocked, e.g., based on edge detection), direction information associated with the UEs, and/or capability information associated with the UEs.

At block 312, the server 304 may construct and generate a UE-specific GFM. The UE-specific GFM may be tailored and customized to the needs of a recipient UE, such as UE 302a. As discussed above, the GFM may represent spatial information and insights that the recipient UE 302a does not possess. The server 304 may generate the UE-specific GFM by first creating a global view associated with the environment of the UEs 302a, 302b, 302n. The global view message may be a union of the awareness messages received from the UEs 302a, 302b, 302n. Since the global view message is a union, it does not contain redundant or overlapping information that repeats from more than one UE. Then, the awareness message(s) from the recipient UE 302a and any other information known to the recipient UE 302a may be removed from the global view message to generate a GFM customized to the recipient UE 302a.

At arrow 314, the server 304 may send the UE-specific GFM to the recipient UE 302a, e.g., via unicast. This process can be applied to any of the UEs 302a, 302b, 302n that is identified as a recipient UE. That is, any of UEs 302a, 302b, 302n can be the recipient UE, and messages obtained from the other UEs other than the recipient UE can be used to generate a GFM specific to the recipient UE.

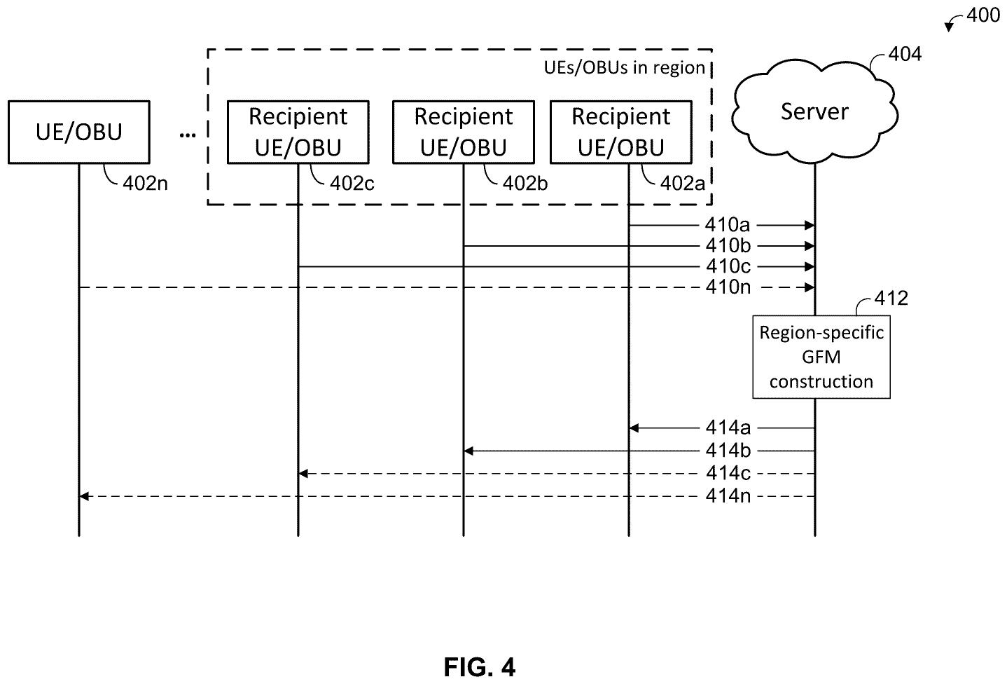

FIG. 4 is a call flow diagram 400 involving UEs 402a-402n (402a, 402b, 402c, 402n) and a server 404, according to some embodiments. Some or all of UEs 402a-402n may be within a region, such as a designated or known location or a region defined relative to a UE (e.g., a radius around a UE). In the example of FIG. 4, UE 402n may be outside the region. At least some of the UEs 402a-402n may be examples of OBUs of vehicles 202a-202c, 222a and 222b shown in FIGS. 2B and 2C, and in some scenarios, may include other types of UEs such as a mobile device carried by a VRU (e.g., 204, 224), as such mobile devices may be capable of sensing or obtaining spatial information and send awareness messages (e.g., BSM, PSM, CPM, and/or SDSM). The server 404 may be a networked cloud server such as server 232.

In some example operations of call flow diagram 400, at arrows 410a-410n (410a, 410b, 410c, 410n), UEs 402a-402n may send respective awareness messages to the server 404. In some scenarios, UE 402n outside the region may not send its awareness message(s) to the server 404. The awareness messages may include various types of contextual information about the environment and the region.

At block 412, the server 404 may construct and generate a region-specific GFM. The region-specific can be applicable to UEs of interest within a region. In some scenarios, the UEs of interest may include UEs 402a and 402b but not 402c or 402n. In this case, UE 402c may not need the GFM, or the GFM may not be useful or applicable to its situation, or UE 402c may not be eligible to receive a GFM (e.g., not subscribed to the service). In some scenarios, the UEs of interest may include UEs 402a, 402b, 402c but not 402n outside the region.

At arrows 414a and 414b, the server 404 may send the region-specific GFM to UEs of interest (e.g., UEs 402a and 402b), e.g., via multicast or broadcast. The region-specific GFM may also be sent individually via unicast. At arrow 414c, if UE 404c is a UE of interest, the UE 404c may also receive the region-specific GFM from the server 404.

Note that UE 402n outside the region may be part of the UEs that have sent awareness messages to the server 404 earlier because UE 402n may have had spatial information that is relevant to the UEs in the region or the UEs of interest. However, UE 402n may not receive the region-specific GFM in some instances. Put another way, some of the UEs from which the server 404 receives awareness messages to build the region-specific GFM may be outside the region. However, in some scenarios, UE 402n may also receive the region-specific GFM from the server 404.

### Methods

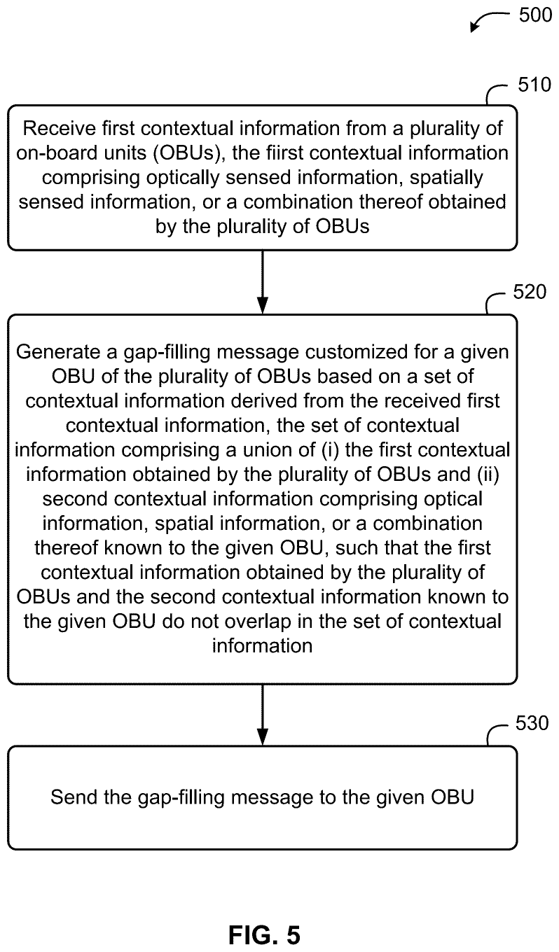

FIG. 5 is a flow diagram of a method 500 of providing spatial awareness to a user equipment (UE) such as an on-board unit (OBU) of a vehicle, according to some embodiments. Structure for performing the functionality illustrated in one or more of the blocks shown in FIG. 5 may be performed by hardware and/or software components of a computer system or a network apparatus, e.g., a server. Components of such computer system or network apparatus may include, for example, one or more data communication interfaces, one or more memory, one or more processors, and/or a computer-readable apparatus including a storage medium storing computer-readable and/or computer-executable instructions that are configured to, when executed by one or more processors, cause the one or more processors or the computer system or the network apparatus to perform operations represented by blocks below. Example components of a computer system or network apparatus are illustrated in FIG. Error! Reference source not found., which is described in more detail below. It should also be noted that the operations of FIG. 5 may be performed in any suitable order, not necessarily the order depicted in FIG. 5. Further, the process shown in FIG. 5 may include additional or fewer operations than those depicted in FIG. 5.

At block 510, the functionality of method 500 may include receiving first contextual information from a plurality of UEs (e.g., OBUs), the first contextual information comprising optically sensed information, spatially sensed information, or a combination thereof obtained by the plurality of OBUs. Examples of optically sensed information may include image data based on image(s) captured by a camera, or image(s) or representation(s) based on signals (e.g., pulse reflections) sensed by a lidar sensor. Examples of spatially sensed information may include RF signals or representation(s) based on signals sensed by a radar sensor. Information from either or both types of modalities may be fused together with awareness messages.

In some embodiments, the first contextual information may include optical image data obtained by one or more of the plurality of OBUs, sensed information associated with one or more objects within an environment of the given OBU, location information corresponding to one or more of the plurality of OBUs, object information associated with one or more objects within an environment associated with one or more of the plurality of OBUs, occlusion information associated with one or more cameras of one or more vehicles, direction information associated with one or more of the plurality of OBUs, capability information associated with one or more of the plurality of OBUs, or a combination thereof. In some implementations, the capability information associated with one or more of the plurality of OBUs may include one or more camera parameters, one or more radio frequency (RF) sensor parameters, or a combination thereof. In some embodiments, the first contextual information may include a Basic Safety Message (BSM), a Personal Safety Message (PSM), a Collective Perception Message (CPM), a Sensor Data Sharing Message (SDSM), or a combination thereof.

In some embodiments, receiving the first contextual information from the plurality of OBUs may include receiving the first contextual information from the plurality of OBUs located within a region; and method 500 may include generating one or more region-specific gap-filling messages based on a region-specific set of contextual information associated with the plurality of OBUs located within the region, the region-specific set of contextual information being at least a subset of the set of contextual information. In some implementations, multicasting or broadcasting the one or more region-specific gap-filling messages to at least a portion of the plurality of OBUs located within the region.

In some embodiments, the spatially sensed information may be indicative of a location of one or more objects within an environment of the given OBU based on radio frequency (RF) sensing.

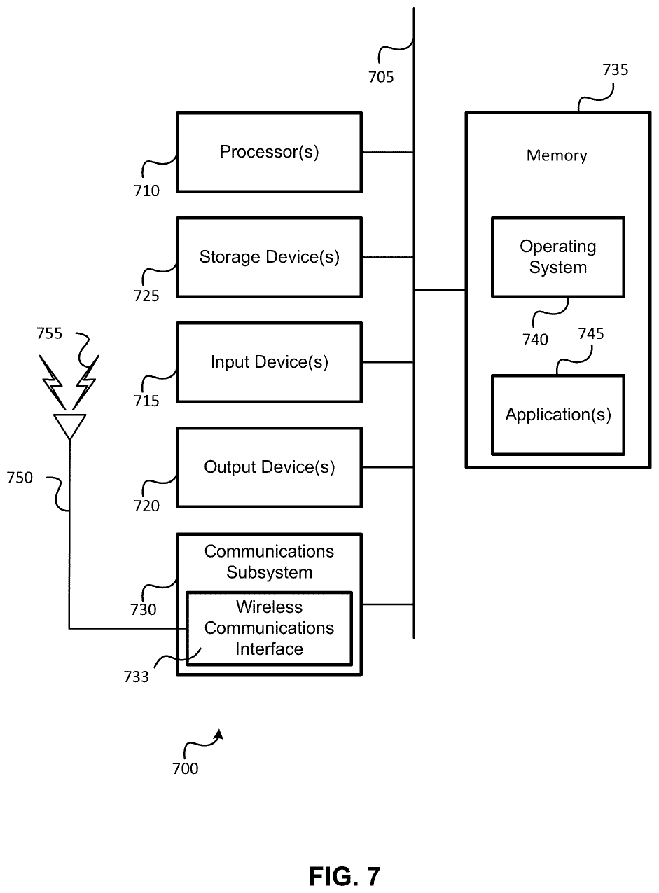

Means for performing functionality at block 510 may comprise storage devices 725, a communications subsystem 730, a communication interface 733, wireless antenna(s) 750, and/or other components of a server, as illustrated in FIG. 7.

At block 520, the functionality of method 500 may include generating a gap-filling message customized for a given OBU of the plurality of OBUs based on a set of contextual information derived from the received first contextual information, the set of contextual information comprising a union of (i) the first contextual information obtained by the plurality of OBUs and (ii) second contextual information comprising optical information, spatial information, or a combination thereof known to the given OBU, such that the first contextual information obtained by the plurality of OBUs and the second contextual information known to the given OBU do not overlap in the set of contextual information.

In some embodiments, the gap-filling message may include at least a portion of a difference between the first contextual information from the plurality of OBUs and the second contextual information known to the given OBU. More specifically, the gap-filling message may include a set difference (e.g., UE-specific GV\Sᵢ as explained above) or a union of gap-filling messages (e.g., region-specific GFM(r)). In some embodiments, the at least the portion of the difference may be representative of occlusion information relating to at least one object that is not in a field of vision of a camera (or another sensor) of the vehicle. That is, the gap-filling message may include the occlusion information relating to the at least one object that is not in the field of vision of the camera (or another sensor) of the vehicle.

Means for performing functionality at block 520 may comprise processor(s) 710, storage devices 725, and/or other components of a server, as illustrated in FIG. 7.

At block 530, the functionality of method 500 may include sending the gap-filling message to the given OBU. In some embodiments, sending the gap-filling message to the given OBU may be based on a subscription service, may be responsive to a request from the given OBU, or a combination thereof.

In some cases, further downstream actions may be taken by the given OBU (UE). In some embodiments, the method 500 may further include determining, based on at least a portion of the received first contextual information, a visual occlusion associated with the given OBU; wherein the gap-filling message sent to the given OBU includes information that compensates for the visual occlusion associated with the given OBU.

In some embodiments, the method 500 may further include generating a map of an environment associated with the plurality of OBUs based on the gap-filling message. In some implementations, the method 500 may further include receiving subsequent contextual information from at least one of the plurality of OBUs; and updating the map of the environment associated with the plurality of OBUs based on the subsequent contextual information.

In some embodiments, the method 500 may further include sending, to the given OBU, visual information configured to enable display of an indication of location information corresponding to the given OBU, an indication of visual occlusion associated with the given OBU, or a combination thereof.

Means for performing functionality at block 530 may comprise a communications subsystem 730, a communication interface 733, wireless antenna(s) 750, as illustrated in FIG. 7.

### Apparatus

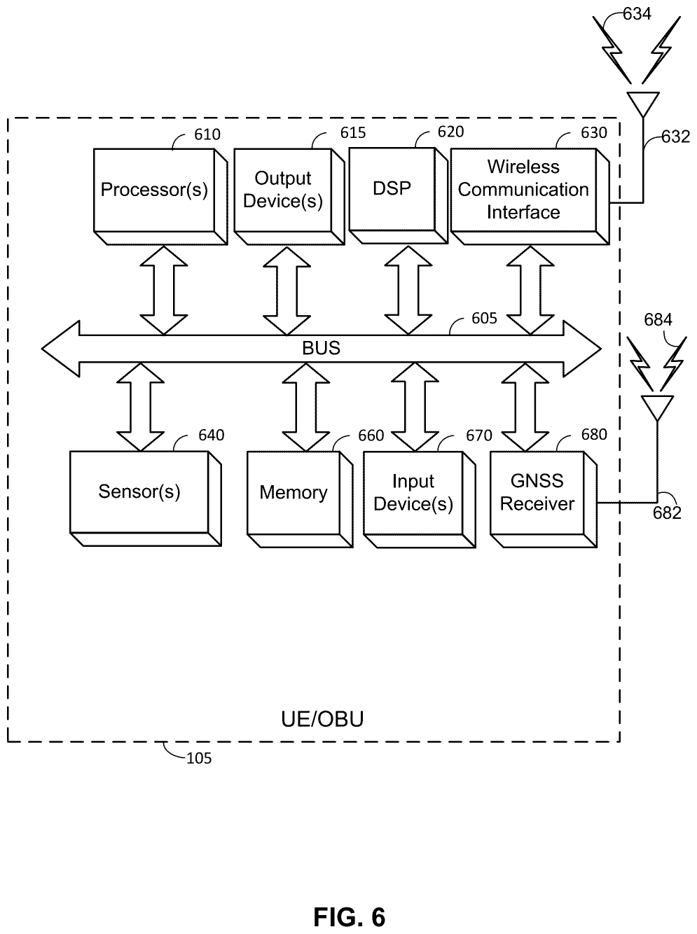

FIG. 6 is a block diagram of an embodiment of a UE 105, which can be utilized as described herein above (e.g., in association with FIGS. 2A-4). It should be noted that FIG. 6 is meant only to provide a generalized illustration of various components, any or all of which may be utilized as appropriate. It can be noted that, in some instances, components illustrated by FIG. 6 can be localized to a single physical device and/or distributed among various networked devices, which may be disposed at different physical locations. Furthermore, as previously noted, the functionality of the UE discussed in the previously described embodiments may be executed by one or more of the hardware and/or software components illustrated in FIG. 6.

The UE 105 is shown comprising hardware elements that can be electrically coupled via a bus 605 (or may otherwise be in communication, as appropriate). The hardware elements may include a processor(s) 610 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 610 may comprise one or more processing units, which may be housed in a single integrated circuit (IC) or multiple ICs. As shown in FIG. 6, some embodiments may have a separate DSP 620, depending on desired functionality. Location determination and/or other determinations based on wireless communication may be provided in the processor(s) 610 and/or wireless communication interface 630 (discussed below). The UE 105 also can include one or more input devices 670, which can include without limitation one or more keyboards, touch screens, touch pads, microphones, buttons, dials, switches, and/or the like; and one or more output devices 615, which can include without limitation one or more displays (e.g., touch screens), light emitting diodes (LEDs), speakers, and/or the like.

The UE 105 may also include a wireless communication interface 630, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the UE 105 to communicate with other devices as described in the embodiments above. The wireless communication interface 630 may permit data and signaling to be communicated (e.g., transmitted and received) with TRPs of a network, for example, via eNBs, gNBs, ng-eNBs, access points, various base stations and/or other access node types, and/or other network components, computer systems, and/or any other electronic devices communicatively coupled with TRPs, as described herein. The communication can be carried out via one or more wireless communication antenna(s) 632 that send and/or receive wireless signals 634. According to some embodiments, the wireless communication antenna(s) 632 may comprise a plurality of discrete antennas, antenna arrays, or any combination thereof. The antenna(s) 632 may be capable of transmitting and receiving wireless signals using beams (e.g., Tx beams and Rx beams). Beam formation may be performed using digital and/or analog beam formation techniques, with respective digital and/or analog circuitry. The wireless communication interface 630 may include such circuitry.

Depending on desired functionality, the wireless communication interface 630 may comprise a separate receiver and transmitter, or any combination of transceivers, transmitters, and/or receivers to communicate with base stations (e.g., ng-eNBs and gNBs) and other terrestrial transceivers, such as wireless devices and access points. The UE 105 may communicate with different data networks that may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The UE 105 can further include sensor(s) 640. Sensor(s) 640 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the UE 105 may also include a Global Navigation Satellite System (GNSS) receiver 680 capable of receiving signals 684 from one or more GNSS satellites using an antenna 682 (which could be the same as antenna 632). Positioning based on GNSS signal measurement can be utilized to complement and/or incorporate the techniques described herein. The GNSS receiver 680 can extract a position of the UE 105, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 680 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 680 is illustrated in FIG. 6 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 610, DSP 620, and/or a processor within the wireless communication interface 630 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), particle filter, or the like. The positioning engine may also be executed by one or more processors, such as processor(s) 610 or DSP 620.

The UE 105 may further include and/or be in communication with a memory 660. The memory 660 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 660 of the UE 105 also can comprise software elements (not shown in FIG. 6), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 660 that are executable by the UE 105 (and/or processor(s) 610 or DSP 620 within UE 105). In some embodiments, then, such code and/or instructions can be used to configure and/or adapt a general-purpose computer (or other device) to perform one or more operations in accordance with the described methods.

FIG. 7 is a block diagram of an embodiment of a computer system 700, which may be used, in whole or in part, to provide the functions of one or more network components as described in the embodiments herein (e.g., location server 160 of FIG. 1). For example, the computer system 700 can perform one or more of the functions of the method shown in FIG. 5. It should be noted that FIG. 7 is meant only to provide a generalized illustration of various components, any or all of which may be utilized as appropriate. FIG. 7, therefore, broadly illustrates how individual system elements may be implemented in a relatively separated or relatively more integrated manner. In addition, it can be noted that components illustrated by FIG. 7 can be localized to a single device and/or distributed among various networked devices, which may be disposed at different geographical locations.

The computer system 700 is shown comprising hardware elements that can be electrically coupled via a bus 705 (or may otherwise be in communication, as appropriate). The hardware elements may include processor(s) 710, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 700 also may comprise one or more input devices 715, which may comprise without limitation a mouse, a keyboard, a camera, a microphone, and/or the like; and one or more output devices 720, which may comprise without limitation a display device, a printer, and/or the like.

The computer system 700 may further include (and/or be in communication with) one or more non-transitory storage devices 725, which can comprise, without limitation, local and/or network accessible storage, and/or may comprise, without limitation, a disk drive, a drive array, an optical storage device, a solid-state storage device, such as a RAM and/or ROM, which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 700 may also include a communications subsystem 730, which may comprise wireless communication technologies managed and controlled by a wireless communication interface 733, as well as wired technologies (such as Ethernet, coaxial communications, universal serial bus (USB), and the like). The wireless communication interface 733 may comprise one or more wireless transceivers that may send and receive wireless signals 755 (e.g., signals according to 5G NR or LTE) via wireless antenna(s) 750. Thus the communications subsystem 730 may comprise a modem, a network card (wireless or wired), an infrared communication device, a wireless communication device, and/or a chipset, and/or the like, which may enable the computer system 700 to communicate on any or all of the communication networks described herein to any device on the respective network, including a User Equipment (UE), base stations and/or other TRPs, and/or any other electronic devices described herein. Hence, the communications subsystem 730 may be used to receive and send data as described in the embodiments herein.

In many embodiments, the computer system 700 will further comprise a working memory 735, which may comprise a RAM or ROM device, as described above. Software elements, shown as being located within the working memory 735, may comprise an operating system 740, device drivers, executable libraries, and/or other code, such as one or more applications 745, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 725 described above. In some cases, the storage medium might be incorporated within a computer system, such as computer system 700. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 700 and/or might take the form of source and/or installable code, which, upon compilation and/or installation on the computer system 700 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:
Clause 1. A method of providing spatial awareness to an on-board unit (OBU) of a vehicle, the method comprising: receiving first contextual information from a plurality of OBUs, the first contextual information comprising optically sensed information, spatially sensed information, or a combination thereof obtained by the plurality of OBUs; generating a gap-filling message customized for a given OBU of the plurality of OBUs based on a set of contextual information derived from the received first contextual information, the set of contextual information comprising a union of (i) the first contextual information obtained by the plurality of OBUs and (ii) second contextual information comprising optical information, spatial information, or a combination thereof known to the given OBU, such that the first contextual information obtained by the plurality of OBUs and the second contextual information known to the given OBU do not overlap in the set of contextual information; and sending the gap-filling message to the given OBU.
Clause 2. The method of clause 1, wherein the gap-filling message comprises at least a portion of a difference between the first contextual information from the plurality of OBUs and the second contextual information known to the given OBU.
Clause 3. The method of any one of clauses 1-2 wherein the at least the portion of the difference is representative of occlusion information relating to at least one object that is not in a field of vision of a camera of the vehicle.
Clause 4. The method of any one of clauses 1-3 wherein receiving the first contextual information from the plurality of OBUs comprises receiving the first contextual information from the plurality of OBUs located within a region; and the method further comprises generating one or more region-specific gap-filling messages based on a region-specific set of contextual information associated with the plurality of OBUs located within the region, the region-specific set of contextual information being at least a subset of the set of contextual information.
Clause 5. The method of any one of clauses 1-4 further comprising multicasting or broadcasting the one or more region-specific gap-filling messages to at least a portion of the plurality of OBUs located within the region.
Clause 6. The method of any one of clauses 1-5 wherein the spatially sensed information is indicative of a location of one or more objects within an environment of the given OBU based on radio frequency (RF) sensing.
Clause 7. The method of any one of clauses 1-6 wherein the first contextual information comprises optical image data obtained by one or more of the plurality of OBUs, sensed information associated with one or more objects within an environment of the given OBU, location information corresponding to one or more of the plurality of OBUs, object information associated with one or more objects within an environment associated with one or more of the plurality of OBUs, occlusion information associated with one or more cameras of one or more vehicles, direction information associated with one or more of the plurality of OBUs, capability information associated with one or more of the plurality of OBUs, or a combination thereof.
Clause 8. The method of any one of clauses 1-7 wherein the capability information associated with one or more of the plurality of OBUs comprises one or more camera parameters, one or more radio frequency (RF) sensor parameters, or a combination thereof.
Clause 9. The method of any one of clauses 1-8 wherein the first contextual information comprises a Basic Safety Message (BSM), a Personal Safety Message (PSM), a Collective Perception Message (CPM), a Sensor Data Sharing Message (SDSM), or a combination thereof.
Clause 10. The method of any one of clauses 1-9 further comprising determining, based on at least a portion of the received first contextual information, a visual occlusion associated with the given OBU; wherein the gap-filling message sent to the given OBU comprises information that compensates for the visual occlusion associated with the given OBU.
Clause 11. The method of any one of clauses 1-10 further comprising generating a map of an environment associated with the plurality of OBUs based on the gap-filling message.
Clause 12. The method of any one of clauses 1-11 further comprising receiving subsequent contextual information from at least one of the plurality of OBUs; and updating the map of the environment associated with the plurality of OBUs based on the subsequent contextual information.
Clause 13. The method of any one of clauses 1-12 further comprising sending, to the given OBU, visual information configured to enable display of an indication of location information corresponding to the given OBU, an indication of visual occlusion associated with the given OBU, or a combination thereof.
Clause 14. The method of any one of clauses 1-13 wherein sending the gap-filling message to the given OBU is based on a subscription service, is responsive to a request from the given OBU, or a combination thereof.
Clause 15. An apparatus comprising: one or more data communication interfaces; one or more memory; and one or more processors communicatively coupled to the one or more data communication interfaces and the one or more memory, the one or more processors configured to: receive first contextual information from a plurality of OBUs, the first contextual information comprising optically sensed information, spatially sensed information, or a combination thereof obtained by the plurality of OBUs; generate a gap-filling message customized for a given OBU of the plurality of OBUs based on a set of contextual information derived from the received first contextual information, the set of contextual information comprising a union of (i) the first contextual information obtained by the plurality of OBUs and (ii) second contextual information comprising optical information, spatial information, or a combination thereof known to the given OBU, such that the first contextual information obtained by the plurality of OBUs and the second contextual information known to the given OBU do not overlap in the set of contextual information; and send the gap-filling message to the given OBU.
Clause 16. The apparatus of clause 15, wherein the gap-filling message comprises at least a portion of a difference between the first contextual information from the plurality of OBUs and the second contextual information known to the given OBU, and the at least the portion of the difference is representative of occlusion information relating to at least one object that is not in a field of vision of a camera associated with the given OBU.
Clause 17. The apparatus of any one of clauses 15-16 wherein receipt of the first contextual information from the plurality of OBUs comprises receiving the first contextual information from the plurality of OBUs located within a region; and the one or more processors are further configured to generate one or more region-specific gap-filling messages based on a region-specific set of contextual information associated with the plurality of OBUs located within the region, the region-specific set of contextual information being at least a subset of the set of contextual information.
Clause 18. The apparatus of any one of clauses 15-17 wherein the one or more processors are further configured to multicast or broadcast the one or more region-specific gap-filling messages to at least a portion of the plurality of OBUs located within the region.
Clause 19. The apparatus of any one of clauses 15-18 wherein the first contextual information comprises optical image data obtained by one or more of the plurality of OBUs, sensed information associated with one or more objects within an environment of the given OBU, location information corresponding to one or more of the plurality of OBUs, object information associated with one or more objects within an environment associated with one or more of the plurality of OBUs, occlusion information associated with one or more cameras of one or more vehicles, direction information associated with one or more of the plurality of OBUs, capability information associated with one or more of the plurality of OBUs, or a combination thereof.
Clause 20. The apparatus of any one of clauses 15-19 wherein the capability information associated with one or more of the plurality of OBUs comprises one or more camera parameters, one or more radio frequency (RF) sensor parameters, or a combination thereof.
Clause 21. The apparatus of any one of clauses 15-20 wherein the first contextual information comprises a Basic Safety Message (BSM), a Personal Safety Message (PSM), a Collective Perception Message (CPM), a Sensor Data Sharing Message (SDSM), or a combination thereof.
Clause 22. The apparatus of any one of clauses 15-21 wherein the one or more processors are further configured to determine, based on at least a portion of the received first contextual information, a visual occlusion associated with the given OBU; and the gap-filling message sent to the given OBU comprises information that compensates for the visual occlusion associated with the given OBU.
Clause 23. The apparatus of any one of clauses 15-22 wherein the one or more processors are further configured to generate a map of an environment associated with the plurality of OBUs based on the gap-filling message.
Clause 24. An apparatus comprising: means for receiving first contextual information from a plurality of OBUs, the first contextual information comprising optically sensed information, spatially sensed information, or a combination thereof obtained by the plurality of OBUs; means for generating a gap-filling message customized for a given OBU of the plurality of OBUs based on a set of contextual information derived from the received first contextual information, the set of contextual information comprising a union of (i) the first contextual information obtained by the plurality of OBUs and (ii) second contextual information comprising optical information, spatial information, or a combination thereof known to the given OBU, such that the first contextual information obtained by the plurality of OBUs and the second contextual information known to the given OBU do not overlap in the set of contextual information; and means for sending the gap-filling message to the given OBU.
Clause 25. The apparatus of clause 24, wherein the gap-filling message comprises at least a portion of a difference between the first contextual information from the plurality of OBUs and the second contextual information known to the given OBU, and the at least the portion of the difference is representative of occlusion information relating to at least one object that is not in a field of vision of a camera associated with the given OBU.
Clause 26. The apparatus of any one of clauses 24-25 wherein the gap-filling message comprises at least a portion of a difference between the first contextual information from the plurality of OBUs and the second contextual information known to the given OBU.
Clause 27. The apparatus of any one of clauses 24-26 wherein the first contextual information comprises optical image data obtained by one or more of the plurality of OBUs, sensed information associated with one or more objects within an environment of the given OBU, location information corresponding to one or more of the plurality of OBUs, object information associated with one or more objects within an environment associated with one or more of the plurality of OBUs, occlusion information associated with one or more cameras of one or more vehicles, direction information associated with one or more of the plurality of OBUs, capability information associated with one or more of the plurality of OBUs, or a combination thereof.
Clause 28. The apparatus of any one of clauses 24-27 wherein the first contextual information comprises a Basic Safety Message (BSM), a Personal Safety Message (PSM), a Collective Perception Message (CPM), a Sensor Data Sharing Message (SDSM), or a combination thereof.
Clause 29. A non-transitory computer-readable apparatus comprising a storage medium, the storage medium comprising a plurality of instructions configured to, when executed by one or more processors, cause an apparatus to: receive first contextual information from a plurality of OBUs, the first contextual information comprising optically sensed information, spatially sensed information, or a combination thereof obtained by the plurality of OBUs; generate a gap-filling message customized for a given OBU of the plurality of OBUs based on a set of contextual information derived from the received first contextual information, the set of contextual information comprising a union of (i) the first contextual information obtained by the plurality of OBUs and (ii) second contextual information comprising optical information, spatial information, or a combination thereof known to the given OBU, such that the first contextual information obtained by the plurality of OBUs and the second contextual information known to the given OBU do not overlap in the set of contextual information; and send the gap-filling message to the given OBU.
Clause 30. The non-transitory computer-readable apparatus of clause 29, wherein the gap-filling message comprises at least a portion of a difference between the first contextual information from the plurality of OBUs and the second contextual information known to the given OBU, and the at least the portion of the difference is representative of occlusion information relating to at least one object that is not in a field of vision of a camera associated with the given OBU.

1. A method of providing spatial awareness to an on-board unit (OBU) of a vehicle, the method comprising:
receiving first contextual information from a plurality of OBUs, the first contextual information comprising optically sensed information, spatially sensed information, or a combination thereof obtained by the plurality of OBUs;
generating a gap-filling message customized for a given OBU of the plurality of OBUs based on a set of contextual information derived from the received first contextual information, the set of contextual information comprising a union of (i) the first contextual information obtained by the plurality of OBUs and (ii) second contextual information comprising optical information, spatial information, or a combination thereof known to the given OBU, such that the first contextual information obtained by the plurality of OBUs and the second contextual information known to the given OBU do not overlap in the set of contextual information; and
sending the gap-filling message to the given OBU.

2. The method of claim 1, wherein the gap-filling message comprises at least a portion of a difference between the first contextual information from the plurality of OBUs and the second contextual information known to the given OBU.

3. The method of claim 2, wherein the at least the portion of the difference is representative of occlusion information relating to at least one object that is not in a field of vision of a camera of the vehicle.

4. The method of claim 1, wherein:
receiving the first contextual information from the plurality of OBUs comprises receiving the first contextual information from the plurality of OBUs located within a region; and
the method further comprises generating one or more region-specific gap-filling messages based on a region-specific set of contextual information associated with the plurality of OBUs located within the region, the region-specific set of contextual information being at least a subset of the set of contextual information.

5. The method of claim 4, further comprising multicasting or broadcasting the one or more region-specific gap-filling messages to at least a portion of the plurality of OBUs located within the region.

6. The method of claim 1, wherein the spatially sensed information is indicative of a location of one or more objects within an environment of the given OBU based on radio frequency (RF) sensing.

7. The method of claim 1, wherein the first contextual information comprises optical image data obtained by one or more of the plurality of OBUs, sensed information associated with one or more objects within an environment of the given OBU, location information corresponding to one or more of the plurality of OBUs, object information associated with one or more objects within an environment associated with one or more of the plurality of OBUs, occlusion information associated with one or more cameras of one or more vehicles, direction information associated with one or more of the plurality of OBUs, capability information associated with one or more of the plurality of OBUs, or a combination thereof.

8. The method of claim 7, wherein the capability information associated with one or more of the plurality of OBUs comprises one or more camera parameters, one or more radio frequency (RF) sensor parameters, or a combination thereof.

9. The method of claim 1, wherein the first contextual information comprises a Basic Safety Message (BSM), a Personal Safety Message (PSM), a Collective Perception Message (CPM), a Sensor Data Sharing Message (SDSM), or a combination thereof.

10. The method of claim 1, further comprising determining, based on at least a portion of the received first contextual information, a visual occlusion associated with the given OBU;
wherein the gap-filling message sent to the given OBU comprises information that compensates for the visual occlusion associated with the given OBU.

11. The method of claim 1, further comprising generating a map of an environment associated with the plurality of OBUs based on the gap-filling message.

12. The method of claim 11, further comprising:
receiving subsequent contextual information from at least one of the plurality of OBUs; and
updating the map of the environment associated with the plurality of OBUs based on the subsequent contextual information.

13. The method of claim 1, further comprising sending, to the given OBU, visual information configured to enable display of an indication of location information corresponding to the given OBU, an indication of visual occlusion associated with the given OBU, or a combination thereof.

14. The method of claim 1, wherein sending the gap-filling message to the given OBU is based on a subscription service, is responsive to a request from the given OBU, or a combination thereof.

15. An apparatus comprising:
one or more data communication interfaces;
one or more memory; and
one or more processors communicatively coupled to the one or more data communication interfaces and the one or more memory, the one or more processors configured to:
receive first contextual information from a plurality of OBUs, the first contextual information comprising optically sensed information, spatially sensed information, or a combination thereof obtained by the plurality of OBUs;
generate a gap-filling message customized for a given OBU of the plurality of OBUs based on a set of contextual information derived from the received first contextual information, the set of contextual information comprising a union of (i) the first contextual information obtained by the plurality of OBUs and (ii) second contextual information comprising optical information, spatial information, or a combination thereof known to the given OBU, such that the first contextual information obtained by the plurality of OBUs and the second contextual information known to the given OBU do not overlap in the set of contextual information; and
send the gap-filling message to the given OBU.

16. The apparatus of claim 15, wherein the gap-filling message comprises at least a portion of a difference between the first contextual information from the plurality of OBUs and the second contextual information known to the given OBU, and the at least the portion of the difference is representative of occlusion information relating to at least one object that is not in a field of vision of a camera associated with the given OBU.

17. The apparatus of claim 15, wherein:
receipt of the first contextual information from the plurality of OBUs comprises receiving the first contextual information from the plurality of OBUs located within a region; and
the one or more processors are further configured to generate one or more region-specific gap-filling messages based on a region-specific set of contextual information associated with the plurality of OBUs located within the region, the region-specific set of contextual information being at least a subset of the set of contextual information.

18. The apparatus of claim 17, wherein the one or more processors are further configured to multicast or broadcast the one or more region-specific gap-filling messages to at least a portion of the plurality of OBUs located within the region.

19. The apparatus of claim 15, wherein the first contextual information comprises optical image data obtained by one or more of the plurality of OBUs, sensed information associated with one or more objects within an environment of the given OBU, location information corresponding to one or more of the plurality of OBUs, object information associated with one or more objects within an environment associated with one or more of the plurality of OBUs, occlusion information associated with one or more cameras of one or more vehicles, direction information associated with one or more of the plurality of OBUs, capability information associated with one or more of the plurality of OBUs, or a combination thereof.

20. The apparatus of claim 19, wherein the capability information associated with one or more of the plurality of OBUs comprises one or more camera parameters, one or more radio frequency (RF) sensor parameters, or a combination thereof.

21. The apparatus of claim 15, wherein the first contextual information comprises a Basic Safety Message (BSM), a Personal Safety Message (PSM), a Collective Perception Message (CPM), a Sensor Data Sharing Message (SDSM), or a combination thereof.

22. The apparatus of claim 15, wherein:
the one or more processors are further configured to determine, based on at least a portion of the received first contextual information, a visual occlusion associated with the given OBU; and
the gap-filling message sent to the given OBU comprises information that compensates for the visual occlusion associated with the given OBU.

23. The apparatus of claim 15, wherein the one or more processors are further configured to generate a map of an environment associated with the plurality of OBUs based on the gap-filling message.

24. An apparatus comprising:
means for receiving first contextual information from a plurality of OBUs, the first contextual information comprising optically sensed information, spatially sensed information, or a combination thereof obtained by the plurality of OBUs;
means for generating a gap-filling message customized for a given OBU of the plurality of OBUs based on a set of contextual information derived from the received first contextual information, the set of contextual information comprising a union of (i) the first contextual information obtained by the plurality of OBUs and (ii) second contextual information comprising optical information, spatial information, or a combination thereof known to the given OBU, such that the first contextual information obtained by the plurality of OBUs and the second contextual information known to the given OBU do not overlap in the set of contextual information; and
means for sending the gap-filling message to the given OBU.

25. The apparatus of claim 24, wherein the gap-filling message comprises at least a portion of a difference between the first contextual information from the plurality of OBUs and the second contextual information known to the given OBU, and the at least the portion of the difference is representative of occlusion information relating to at least one object that is not in a field of vision of a camera associated with the given OBU. 26 (Original) The apparatus of claim 24, wherein the gap-filling message comprises at least a portion of a difference between the first contextual information from the plurality of OBUs and the second contextual information known to the given OBU.

27. The apparatus of claim 24, wherein the first contextual information comprises optical image data obtained by one or more of the plurality of OBUs, sensed information associated with one or more objects within an environment of the given OBU, location information corresponding to one or more of the plurality of OBUs, object information associated with one or more objects within an environment associated with one or more of the plurality of OBUs, occlusion information associated with one or more cameras of one or more vehicles, direction information associated with one or more of the plurality of OBUs, capability information associated with one or more of the plurality of OBUs, or a combination thereof.

28. The apparatus of claim 24, wherein the first contextual information comprises a Basic Safety Message (BSM), a Personal Safety Message (PSM), a Collective Perception Message (CPM), a Sensor Data Sharing Message (SDSM), or a combination thereof.

29. A non-transitory computer-readable apparatus comprising a storage medium, the storage medium comprising a plurality of instructions configured to, when executed by one or more processors, cause an apparatus to:
receive first contextual information from a plurality of OBUs, the first contextual information comprising optically sensed information, spatially sensed information, or a combination thereof obtained by the plurality of OBUs;
generate a gap-filling message customized for a given OBU of the plurality of OBUs based on a set of contextual information derived from the received first contextual information, the set of contextual information comprising a union of (i) the first contextual information obtained by the plurality of OBUs and (ii) second contextual information comprising optical information, spatial information, or a combination thereof known to the given OBU, such that the first contextual information obtained by the plurality of OBUs and the second contextual information known to the given OBU do not overlap in the set of contextual information; and
send the gap-filling message to the given OBU.

30. The non-transitory computer-readable apparatus of claim 29, wherein the gap-filling message comprises at least a portion of a difference between the first contextual information from the plurality of OBUs and the second contextual information known to the given OBU, and the at least the portion of the difference is representative of occlusion information relating to at least one object that is not in a field of vision of a camera associated with the given OBU.
